(19) United States
(12) Patent Application Publication
(10) Pub. No.: US 2015/0144070 A1
(43) Pub. Date: May 28, 2015

(54) PET CARRIER WITH DOOR LOCK

(71) Applicant: JIANGSU ZHONGHENG PET ARTICLES JOINT-STOCK CO.,LTD, Jiangsu (CN)

(72) Inventor: Bin QIU, Jiangsu (CN)

(21) Appl. No.: 14/553,316

(22) Filed: Nov. 25, 2014

(30) Foreign Application Priority Data
Nov. 27, 2013 (CN) 201320791726.2

(51) Int. Cl. A01K 1/02; E05B 65/52

(52) U.S. Cl. CPC A01K 1/0245; E05B 65/52
USPC 119/496

(57) ABSTRACT

A pet carrier for carrying a pet includes an upper cover body and a lower cover body, and an opening/closing pet door connecting with the upper and lower cover bodies. An opening/closing door rotating steel post is provided on the left side of the opening/closing pet door and has two ends fixed to the upper cover body and lower cover body, respectively. The pet carrier further includes a horizontal door lock and a vertical door lock provided on the opening/closing pet door. A pair of springs is provided on the horizontal door lock steel ribs; and another pair of springs is provided on the vertical door lock steel ribs. Each door lock is provided with a door lock controller, a door lock top cover and a door lock bottom cover. The horizontal door lock and the vertical door lock define a double door lock structure.

### CROSS REFERENCE TO RELATED APPLICATION

The present application is based on, and claims priority from, Chinese Application Number 201320791726.2, filed Nov. 27, 2013, the disclosure of which is incorporated herein by reference in its entirety.

### TECHNICAL FIELD

The present disclosure relates to a pet carrier, in particular to a pet carrier with a door lock.

### BACKGROUND

As society develops, people are not only enjoying material life but are also in endless pursuit of a spiritual life, with the number of people who like to keep pets of all kinds increasing all the time. People often take their pets outside to play. However, there are always places outside where it is not convenient for a pet to play around, such as when the pet runs onto a main road, or moves around when staying in a vehicle. Therefore, people usually use a pet carrier for carrying the pet outside, especially when the pet is small. Most pet carriers currently on the market are made of fabric, and closable with a zip. However, some pets like biting or tearing fabric bags or boxes, and thus the pets may escape from the damaged bags or boxes. In response to these problems, there have been improvements in design of these pet carriers; however, none of the improvements are able to entirely solve the above problems in conventional pet carriers.

### BRIEF DESCRIPTION OF THE DRAWINGS

The present disclosure will be further described in conjunction with drawings and embodiments. Aspects of the present disclosure are to be understood from the following detailed description when read with the accompanying figures which are incorporated herein by reference.

FIG. 1 is a front view of a pet carrier having a door lock in accordance with at least one embodiment.

FIG. 2 is a schematic perspective view of a door of the pet carrier in accordance with an embodiment.

FIG. 3 is another schematic perspective view of the door of the pet carrier in accordance with an embodiment.

FIG. 4 is an enlarged schematic perspective view of the door lock 5 as shown in FIG. 3.

FIG. 5 is a schematic perspective view of the pet carrier when the door is closed in accordance with an embodiment.

FIG. 6 is a schematic perspective view of the pet carrier when the door is open in accordance with an embodiment.

### DETAILED DESCRIPTION

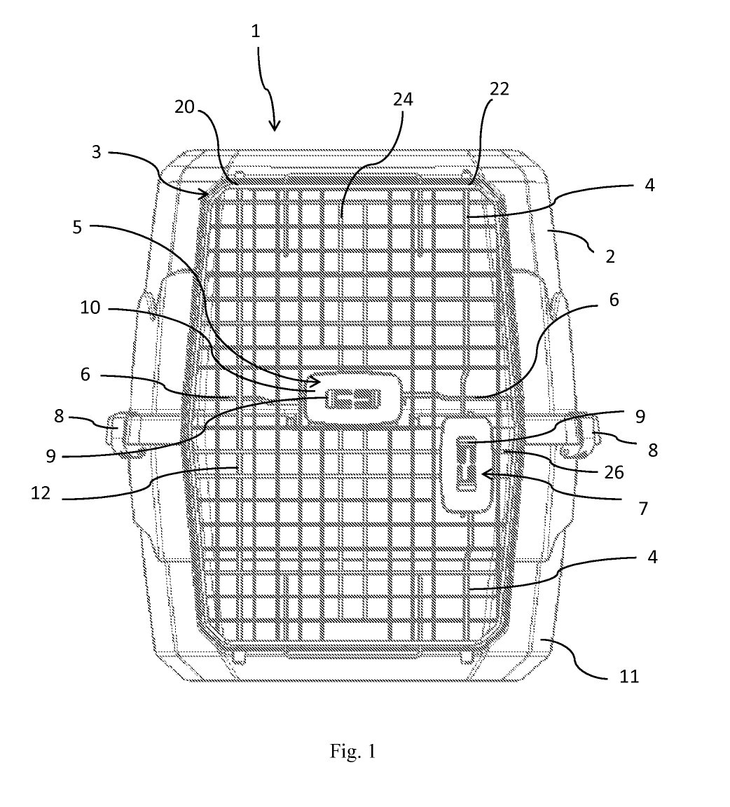

An embodiment, as described in connection with FIG. 1, is a pet carrier 1. The pet carrier 1 includes an upper cover body 2 and a lower cover body 11, which are fixed in place by fastening elements, e.g., fasteners 8. The pet carrier 1 further includes an opening/closing door 3 on a side of the pet carrier 1. In at least one embodiment, the opening/closing door 3 is made from welded steel wires, and in a form of a mesh. The opening/closing door 3 is connected to the upper cover body 2 and the lower cover body 11 of the pet carrier 1 by an opening/closing door rotating post 12. In at least one embodiment as shown in FIG. 1, the opening/closing door rotating post 12 is provided on the left side of the opening/closing door 3, and upper and lower ends of the opening/closing door rotating post 12 are inserted into openings 20 of the upper cover body 2 and lower cover body 11, respectively. In at least some embodiments, post 12 is made of steel.

Pet carrier 1 further includes two door locks, e.g., a horizontal door lock 5 and a vertical door lock 7. The horizontal door lock 5 is between the vertical door lock 7 and the post 12. The horizontal door lock 5 and the vertical door lock 7 are provided on the opening/closing door 3. In at least one embodiment, the horizontal door lock 5 is disposed in a middle part of the opening/closing door 3 in a horizontal direction of the pet carrier 1, while the vertical door lock 7 is disposed on the right side of the opening/closing door 3 and closer to the bottom of the pet carrier 1 than the horizontal door lock 5. The location of the horizontal door lock 5 and the vertical door lock 7 are not limited to the location shown in FIG. 1. Other locations for the horizontal door lock 5 and the vertical door lock 7 are within the scope of various embodiments. The horizontal door lock 5 is fixed to the opening/closing door 3 by vertical door lock ribs 24 at the top and bottom of the horizontal door lock 5. Two horizontal door lock ribs 6 on the left and right of the horizontal door lock 5 are configured to retain the door 3 in a closed or engaged position with the carrier 1. In at least some embodiments, lock ribs 6 are made of steel. The vertical door lock 7 is fixed to the right side of the opening/closing pet door 3 by horizontal door lock ribs 26 on the left and right of the vertical door lock 7. Two vertical door lock ribs 4 at the top and bottom of the vertical door lock 7 are configured to retain the door 3 in a closed or engaged position with the carrier 1. In at least some embodiments, lock ribs 4 are made of steel.

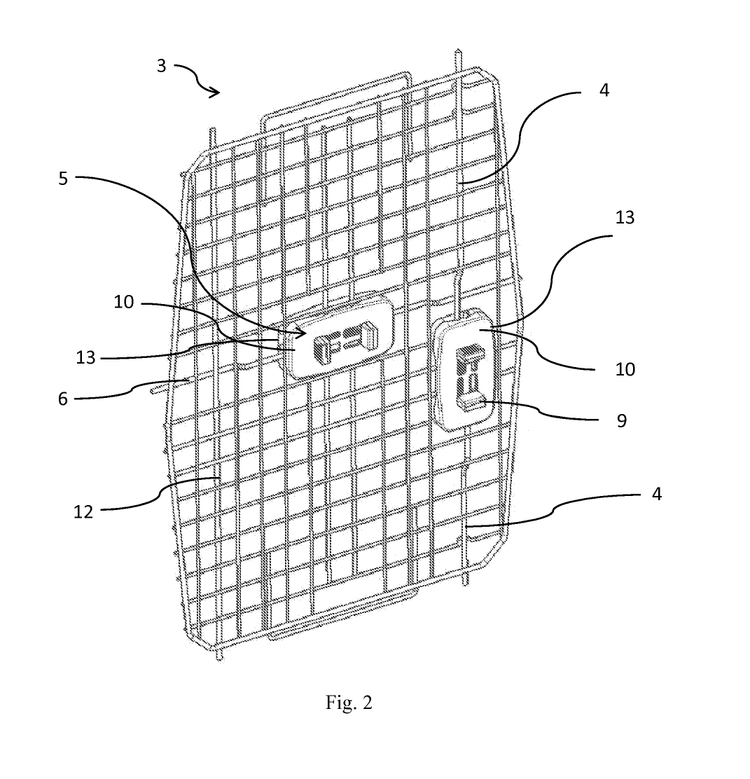

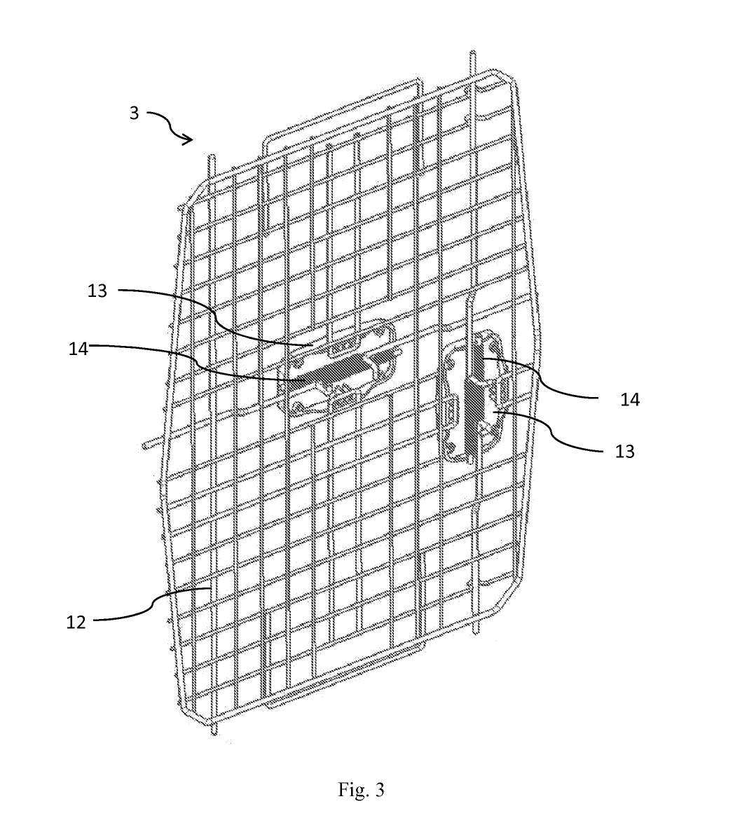

In connection with FIGS. 2 and 3, the horizontal door lock 5 includes a door lock front cover 10 and a door lock back cover 13 attached to the door lock front cover 10. The horizontal door lock 5 further includes a pair of controllers 9 projecting outwardly from the door lock front cover 10. A pair of elastic members, e.g., springs 14 is provided on the horizontal door lock ribs 6 and covered by the front cover 10 and the back cover 13. The pair of springs 14 are biased in opposing directions to each other such that the lock ribs 6 are urged away from the horizontal door lock 5.

Further in connection with FIGS. 2 and 3, the vertical door lock 7 includes a door lock front cover 10 and a door lock back cover 13 attached to the door lock front cover 10. The horizontal door lock 7 further includes a pair of controllers 9 projecting outwardly from the door lock front cover 10. The vertical door lock 7 is also provided with a pair of springs 14 on the vertical door lock steel ribs 4.

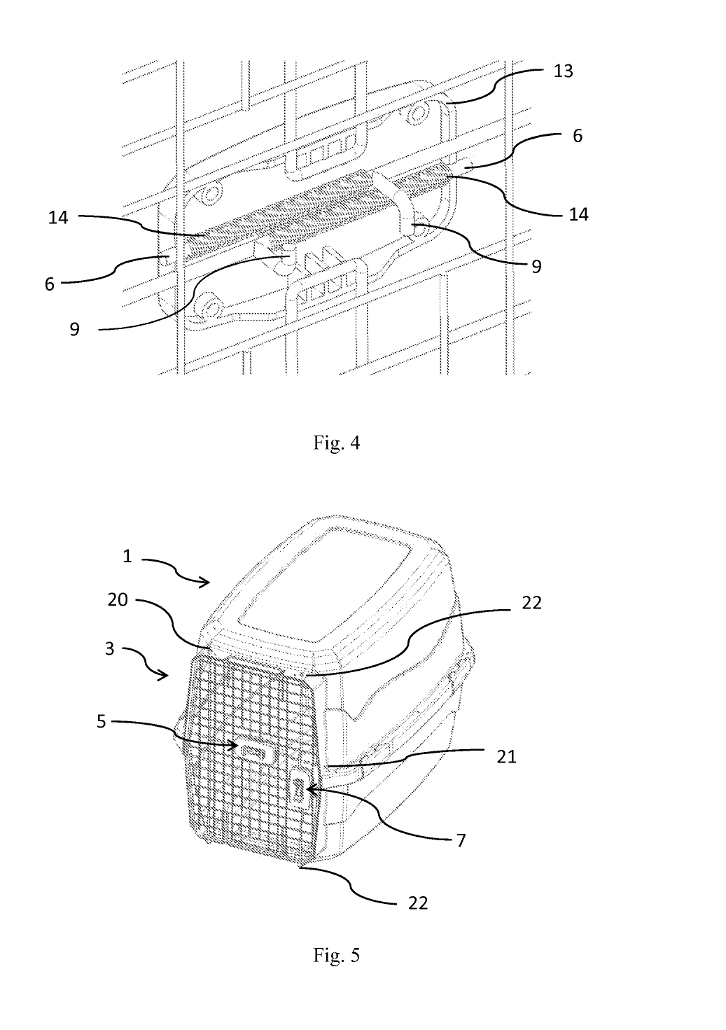

FIG. 4 is an enlarged view of the horizontal door lock 5 where the door lock front cover 10 is omitted for illustrating inside of the horizontal door lock 5. In at least one embodiment, each of the springs 14 is biased between the control 9 and an edge of the door lock back cover 13 to urge a rib away from the door lock 5.

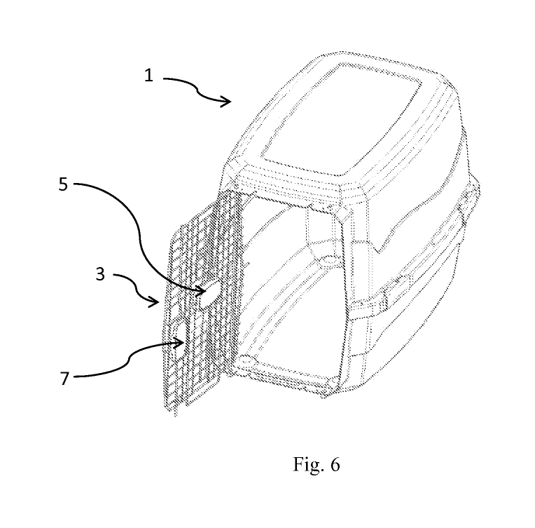

According to FIGS. 1-6, the horizontal door lock ribs 6 are disposed side by side in the vertical direction and each of the ribs 6 extends horizontally to be inserted into a receptacle 21 on a side edge of the upper cover body 2 when the door lock 5 is locked. The door lock is in a locked position if the ribs 6 are extended due to the urging of springs 14. The door lock is in an unlocked position if the ribs 6 are retracted due to the manipulation of controllers 9 toward each other in a horizontal direction. In at least one embodiment, a single controller 9 is manipulated to retract a rib 6 against the urging of a corresponding spring 14. The vertical door lock ribs 4 are disposed side by side in the horizontal direction. One of the ribs 4 extends vertically upward to be inserted into a receptacle 22 on an edge of the upper cover body 2 and the other one of the ribs 4 extends vertically downward to be inserted into a receptacle 22 on an edge of the lower cover body 11.

With regard to the pet carrier door lock, by providing two door locks, a horizontal door lock 5 and a vertical door lock 7, as a double door lock structure on the opening/closing door 3 of the pet carrier 1, firm locking of the opening/closing door 3 on the pet carrier 1 is ensured. When the door lock controllers 9 of the horizontal door lock 5 are pushed toward each other to compress the pair of springs 14, the ends of the horizontal door lock ribs 6 are moved out of the receptacle 21 on the side edges of the upper cover body 2 and therefore the door lock 5 opens. When the door lock controllers 9 are pushed toward each other to compress the pair of springs 14, the ends of the vertical door lock steel ribs 4 are moved out of the receptacle 22 of the upper cover body 2 and the receptacle 22 of the lower cover body 11 and therefore the door lock 7 opens. When the horizontal door lock 5 and the vertical door lock 7 are opened, the opening/closing door 3 can be opened by turning the opening/closing door and rotating post 12 on the opening/closing door 3.

When the door lock controllers 9 of the horizontal door lock 5 are moved away from each other to release the pair of springs 14 provided on the two horizontal door lock ribs 6, the pair of springs 14 are relaxed and the ends of the vertical door lock ribs 6 are inserted into the openings 21 of the side edges of the upper cover body 2 and therefore the door lock 5 closes. When the door lock controllers 9 of the vertical door lock 7 are moved away from each other to release the pair of springs 14 provided on the two vertical door lock ribs 4, the pair of springs 14 are relaxed and the vertical door lock ribs 4 are inserted into the openings 22 of the upper cover body 2 and lower cover body 11 of the pet carrier 1 and the door lock 7 closes. Therefore, the opening/closing door 3 is locked firmly at the top, bottom, left and right of the pet carrier 1.

The pet carrier in at least some embodiments is safe and prevents pets from escaping and running around everywhere.

In some embodiments, a pet carrier, including a body, a door having a door post, ends of the door post being connected to the body, and a first door lock mounted to the door and elongated in a horizontal direction. The first lock includes a pair of first door lock ribs extending in the horizontal direction and insertable into first openings of the body, and a pair of controllers opposing each other in the horizontal direction. When the pair of controllers of the first lock is moved away from each other, the pair of first door lock ribs is inserted into the first openings. When the pair of controllers of the first lock is moved toward each other, the pair of first door lock ribs is moved out of the first openings.

In some embodiments, the pet carrier further includes a second lock mounted to the door and elongated in a vertical direction. The second lock includes a pair of second door lock ribs extending in the vertical direction and insertable into second openings of the body, and a pair of controllers opposing each other in the vertical direction. When the pair of controllers of the second lock is moved away from each other, the pair of second door lock ribs is inserted into the second openings. When the pair of controllers of the second lock is moved toward each other, the pair of second door lock ribs is moved out of the second openings.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A pet carrier, comprising:
a body;
a door connected to the body; and
a first door lock mounted to the door and elongated in a horizontal direction;
a second door lock mounted to the door and elongated in a vertical direction, wherein the first lock includes
a pair of first door lock ribs extending in the horizontal direction and insertable into first openings of the body, and
a pair of controllers opposing each other in the horizontal direction, wherein the second lock includes
a pair of second door lock ribs extending in the vertical direction and insertable into second openings of the body, and
a pair of controllers opposing each other in the vertical direction, wherein
when the pair of controllers of the first door lock is moved away from each other, the pair of first door lock ribs is inserted into the first openings, and
when the pair of controllers of the first door lock is moved toward each other, the pair of first door lock ribs is moved out of the first openings, wherein
when the pair of controllers of the second door lock are moved away from each other, the pair of second door lock ribs are inserted into the second openings, and
when the pair of controllers of the second door lock are moved toward each other, the pair of second door lock ribs are retracted from the second openings.

2. The pet carrier according to claim 1, wherein the first door lock is disposed in a middle part of the door in the horizontal direction, and the second door lock is disposed adjacent to the first door lock in the horizontal direction and closer to a bottom of the body than the first door lock in the vertical direction.

3. The pet carrier according to claim 1, wherein
the first door lock further comprises a front cover; and a back cover secured to the front cover, and
the pair of controllers projects outside the front cover.

4. The pet carrier according to claim 3, wherein the first door lock further comprises a pair of elastic members inside the front and back covers and between the controllers and edges of the front and back covers.

5. The pet carrier according to claim 1, wherein
the second door lock further comprises a front cover; and a back cover secured to the front cover, and
the pair of controllers projects outside the front cover.

6. The pet carrier according to claim 5, wherein the second door lock further comprises a pair of elastic members disposed inside the front and back covers and between the controllers and edges of the front and back covers.

7. The pet carrier according to claim 1, further comprising a door post having an end inserted into a receptacle of an upper cover body of the body and another end inserted into a receptacle of a lower cover body of the body, wherein
the door is rotatable along the door post to open or close the body, and
the first door lock is between the door post and the second door lock.

8. A pet carrier comprising:
a body having an opening;
a door rotatable to close or open the opening;
a first door lock attached to the door and including a pair of first ribs movable in a first direction; and
a second door lock attached to the door and including a pair of second ribs movable in a second direction, wherein the second direction differs from the first direction.
